(19) United States
(12) Patent Application Publication
(10) Pub. No.: US 2017/0083235 A1
(43) Pub. Date: Mar. 23, 2017

(54) Device capable of using external volatile memory and device capable of releasing internal volatile memory

(71) Applicant: Realtek Semiconductor Corporation, Hsinchu (TW)

(72) Inventors: CHENG-YU CHEN, NEW TAIPEI CITY (TW); CHIH-CHING CHIEN, HSINCHU COUNTY (TW); WANG-SHENG LIN, NEW TAIPEI CITY (TW)

(21) Appl. No.: 15/273,083

(22) Filed: Sep. 22, 2016

(30) Foreign Application Priority Data
Sep. 23, 2015 (TW) 104131346

(51) Int. Cl. G06F 3/06; G06F 12/06

(52) U.S. Cl. CPC G06F 3/061; G06F 3/0631; G06F 3/0685; G06F 12/0638; G06F 3/0655; G06F 2212/205

(57) ABSTRACT

The present invention includes a device capable of using an external volatile memory. An embodiment of the device comprises: a storage controller operable to control the data access of a non-volatile storage medium and communicate with an external device, the external device controlling an external volatile memory. The said storage controller is operable to treat at least a part of the external volatile memory as a cache memory under an external-cache mode through the following steps: requesting the external device to provide a required amount of memory; detecting whether the external device provides an allocated memory according to a response from the external device; operating under a non-external-cache mode if none of the allocated memory is provided; and operating under the external-cache mode if the allocated memory is provided, and thereby treating the allocated memory as the said cache memory.

### BACKGROUND OF THE INVENTION

1. Field of the Invention

The present invention relates to the management of cache space, especially to a device capable of using an external volatile memory and a device capable of releasing an internal volatile memory.

2. Description of Related Art

In order to accelerate data access, some storage device makes use of a built-in cache memory (e.g., a random access memory) to store a cache data table and/or cache data and store an address mapping table. In consideration of cost, some storage device is equipped with a built-in cache memory of less capacity or with no cache memory. A storage device with sufficient built-in cache memory capacity will face the burden of cost particularly when the requirement of cache memory capacity rises as the capacity of the storage device increases. On the other hand, a storage device with insufficient or no built-in cache memory capacity will consume a lot of computation resources in data access operation, and thereby suffer the degradation of performance, which is especially serious when executing access operation with random addresses. In addition, when the major storage medium of a storage device is a flash memory, since the erase/write times of a flash memory is limited, the absence or shortage of cache space will reduce the lifetime of such storage device.

Take a computer system for example A general computer system executes data addressing through logical block addresses (LBAs) for accessing a storage device (e.g., a solid state drive, SSD). The algorithm of the said data addressing may vary with the non-volatile storage medium type and process technique of the storage device, and may not be fulfilled by using LBAs directly due to the limit of read/write times of the non-volatile storage medium (e.g., flash memory). Therefore, a storage device usually has to do address mapping when executing data access operation by LBAs, so as to convert LBAs that a computer system recognizes into physical addresses of the storage device. However, if such address mapping has to be carried out for data access operation every time (while some data might be accessed frequently), the performance of such data access operation will be degraded. Therefore, a conventional art uses a cache data table and a physical-to-logical address mapping table to record the relation between physical addresses and LBAs of cache data so as to prevent performance lost caused by additional time for rebuilding address mapping relation every time, in which the cache data table includes the information of LBAs and the physical-to-logical address mapping table includes the connection between LBAs and physical addresses. Although the usage of the aforementioned mapping table can prevent performance lost, the storage of such mapping table will consume cache space (e.g., a random access memory) of a storage device and the size of the storage device will confine the size of the mapping table. More specifically, the absence or shortage of the cache space will lower the data access performance of the storage device, but the abundance of the cache device will lead to the increase of cost. Such dilemma has haunted manufacturers in this field.

### SUMMARY OF THE INVENTION

In view of the problem of the prior art, an object of the present invention is to provide a device capable of using an external volatile memory, a device capable of releasing an internal volatile memory and a system capable of providing cache space so as to make improvements over the prior art.

The present invention discloses a device capable of using an external volatile memory. An embodiment of the device comprises: a storage controller operable to control data access of a non-volatile storage medium and communicate with an external device, the external device controlling an external volatile memory. In addition, the storage controller is operable to treat at least a part of the external volatile memory as a cache memory under an external-cache mode through the following steps: requesting the external device to provide a required amount of memory; detecting whether the external device provides an allocated memory according to a response to the request of the required amount of memory from the external device; operating under a non-external-cache mode if the external device does not provide the allocated memory; and operating under the external-cache mode if the external device provides the allocated memory, and thereby treating the allocated memory as the cache memory.

The present invention also discloses a device capable of releasing an internal volatile memory. An embodiment of the device comprises: a volatile memory; and a storage controller operable to communicate with an external device and release at least a part of the volatile memory to the external device. The storage controller is further operable to execute the following step after the release of the at least a part of the volatile memory: building a cache table and storing the cache table in an unreleased part of the volatile memory according to the capacity of the unreleased part and/or storing cache data in the unreleased part according to the capacity of the unreleased part, wherein the cache table indicates address information of the cache data in the unreleased part.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates the device capable of using an external volatile memory according to an embodiment of the present invention.

FIG. 2 illustrates an embodiment of the steps carried out by the storage controller of FIG. 1.

FIG. 3 illustrates an example of the steps included in step S240 of FIG. 2.

FIG. 4 illustrates the method capable of using an external volatile memory according to an embodiment of the present invention.

FIG. 5 illustrates the device capable of releasing an internal volatile memory according to an embodiment of the present invention.

FIG. 6 illustrates the system capable of providing cache space according to an embodiment of the present invention.

### DETAILED DESCRIPTION OF THE PREFERRED EMBODIMENTS

The following description is written by referring to terms acknowledged in this invention field. If any term is defined in this specification, such term should be explained accordingly.

The present disclosure includes a device and method capable of using an external volatile memory, a device capable of releasing an internal volatile memory and a system capable of providing cache space. On account that some element of the device and system are known in this field, the details of such element are omitted given that these omissions have little to do with features of the present invention. Besides, the method of the present invention can be in the form of firmware and/or software which could be carried out by the device of the present invention or the equivalent thereof.

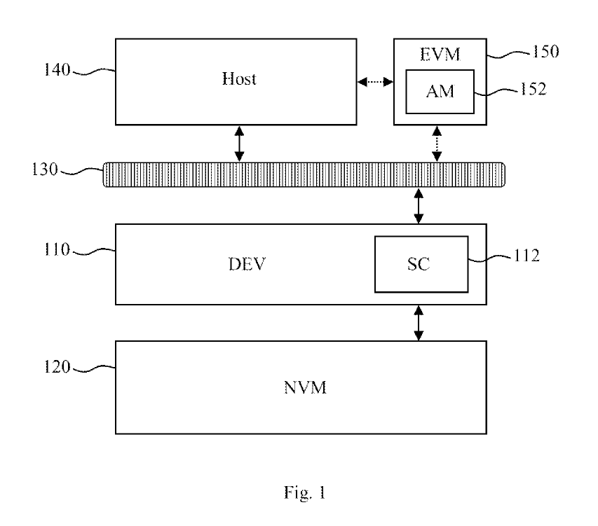

Please refer to FIG. 1 which illustrates the device capable of using an external volatile memory according to an embodiment of the present invention. As it is shown in FIG. 1, the device 110 (which is labeled with “DEV”) in this embodiment includes: a storage controller 112 (which is labeled with “SC”) operable to control data access of a non-volatile storage medium 120 (which is labeled with “NVM”), and operable to communicate with an external device 140 (which is labeled with “Host”) according to at least one of a protocol and a driver (e.g., a driver program) through an interface 130 (e.g., a known interface in compliance with a PCI-Express protocol or a SATA protocol). The said protocol or driver can be realized with well-known techniques and the content of the protocol or driver should include code or program code in association with the steps carried out by the storage controller 112. In practice, one of ordinary skill in the art can draft and edit the code and/or program code in accordance with the present disclosure, well-known specification (e.g., PCI-Express specification such as PCI EXPRESS BASE SPECIFICATION, REVISION 3.0, NVM-Express specification such as NVM Express revision 1.2 specification, etc.), and available software/firmware editing tool. The external device 140 could be a personal computer or a mobile device, and capable of controlling an external volatile memory 150 (which is labeled with “EVM”) such as a random access memory. The memory 150 could be a host memory under the control of the external device 140 (while the external device 140 can communicate with the memory 150 through a memory transmission interface (not shown) without using the interface 130), or the memory 150 could be the memory released from some external storage device according to at least one of the aforementioned protocol and driver for the external device 140 to make use of it (while the external device 140 may communicate with the memory 150 through the transmission interface 130). The said communication between the external device 140 and the memory 150 is shown with dotted lines, and at least one of the dotted lines, that is to say a communication path, in FIG. 1 is required. The aforementioned non-volatile memory 120 such as a flash memory (e.g., NAND flash memory) could be included in the device 110 (while the device 110 could be a storage device) or independent of the device 110 (while the device 110 could be a storage controller without any storage mediums).

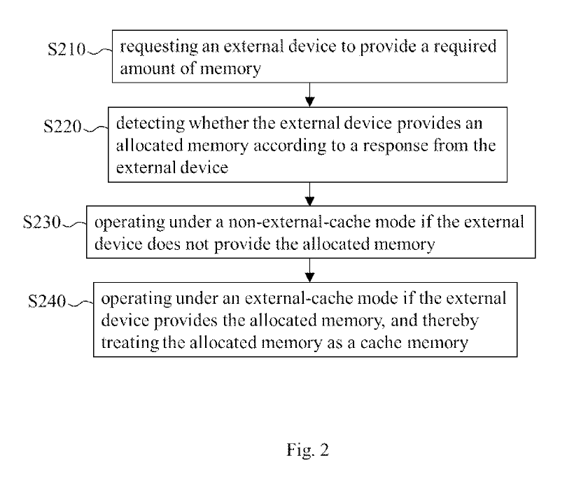

Please refer to FIG. 1 and FIG. 2. The storage controller 112 can treat at least a part of the external volatile memory 150 as a cache memory (i.e., the allocated memory 152 (which is labeled with “AM”) hereafter) under an external-cache mode by executing the following steps:
Step S210: requesting the external device 140 to provide a required amount of memory. The controller 112 is operable to carry out this step according to at least one of the aforementioned protocol and driver.
Step S220: detecting whether the external device 140 provides an allocated memory 152 according to a response to the request of the required amount of memory from the external device 140. The capacity (i.e., storage capacity) of the allocated memory 152 could be the same as or different from the capacity of the required amount of memory, depending on how much capacity of the external volatile memory 150 is under the control of the external device 140 and depending on the memory allocation determined by the aforementioned protocol and/or driver.
Step S230: operating under a non-external-cache mode if the external device 140 does not provide the allocated memory 152. When operating under the non-external-cache mode, if an internal volatile memory is available to be a cache memory, the storage controller 112 will treat a part of the data stored in the non-volatile medium 120 as cache data and store the cache data and/or a cache table (which includes a cache data table and/or a physical-to-logical address mapping table) in the internal volatile memory, wherein the cache table indicates the address information of the cache data in the internal volatile memory and/or the address information of the cache data in the non-volatile storage medium 120. However, if there is no such internal volatile memory, the storage controller 112 will do address mapping first and then access data of the non-volatile storage medium 120 every time.
Step S240: operating under the external-cache mode if the external device 140 provides the allocated memory 152, and thereby treating the allocated memory 152 as the cache memory.

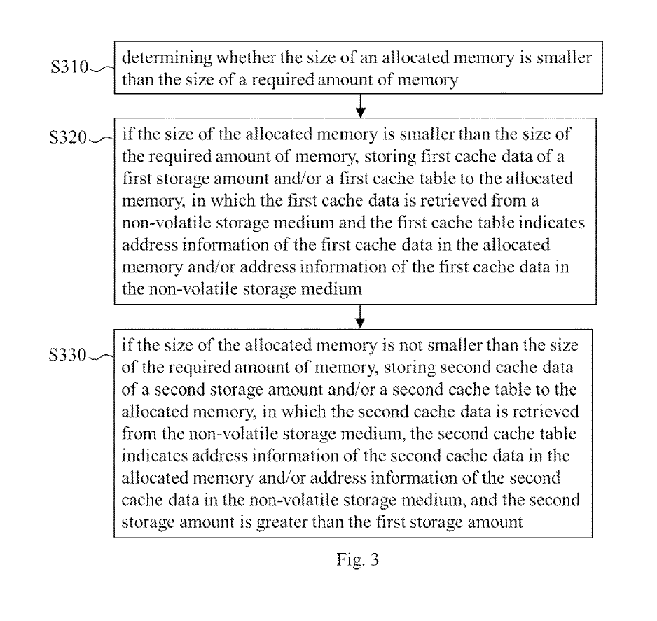

On the basis of the above description, the storage controller 112 can optionally specify the capacity of the required amount of memory. For instance, the storage controller 112 may determine the capacity of the required amount of memory in accordance with the capacity of the non-volatile storage medium 120, and then ask the external device 140 to provide a memory in compliance with the capacity of the required amount of memory. Generally, the more the capacity of the non-volatile storage medium 120, the more the capacity of the required amount of memory. Accordingly, the capacity of the required amount of memory is normally enough for storing the cache table and/or cache data of the non-volatile storage medium 120. Provided that step S210 indicates the capacity of the required amount of memory, step S240 may optionally include the following steps as shown in FIG. 3:
Step S310: determining whether the capacity of the allocated memory 152 is smaller than the capacity of the required amount of memory.
Step S320: if the capacity of the allocated memory 152 is smaller than the capacity of the required amount of memory, storing first cache data of a first storage amount and/or a first cache table (which includes a first cache data table and/or a first physical-to-logical address mapping table) to the allocated memory 152, in which the first cache data can be retrieved from the non-volatile storage medium 120 and the first cache table indicates address information of the first cache data in the allocated memory 152 and/or address information of the first cache data in the non-volatile storage medium 120. More specifically, when the capacity of the allocated memory 152 is less than the capacity of the required amount of memory, the storage controller 112 can merely store a part of qualified cache data and/or a reduced-size cache table in the allocated memory 152, and choose the part of the qualified cache data as the first cache data and build the content of the cache cable according to a predetermined rule. The predetermined rule could be a rule to select data as cache data according to a built-in data table and/or according to a predetermined algorithm (e.g., Least Recently Used (LRU) algorithm). In practice, the predetermined rule could be any of the existing rules for choosing cache data or a self-defined rule.
Step S330: if the capacity of the allocated memory 152 is not smaller than the capacity of the required amount of memory, storing second cache data of a second storage amount and/or a second cache table (which includes a second cache data table and/or a second physical-to-logical address mapping table) to the allocated memory 152, in which the second cache data can be retrieved from the non-volatile storage medium 120, the second cache table indicates address information of the second cache data in the allocated memory 152 and/or address information of the second cache data in the non-volatile storage medium 120, and the second storage amount is greater than the first storage amount. More specifically, when the capacity of the allocated memory 152 is sufficient, the storage controller 112 can store all qualified cache data and/or a full-size cache table in the allocated memory 152, in which the cache data could be chosen according to the aforementioned predetermined rule and the content of the cache table could be built according to the same. In this embodiment, the data amount of the second cache table is greater than the data amount of the first cache table; however, in consideration of the characteristics of data such as unit size and continuity, the storage space for keeping the second cache table could be less than the storage space for keeping the first cache table.

On the basis of the above description, if both the allocated memory 152 and the aforementioned internal volatile memory are available, in order to make use of them flexibly, step S240 may optionally include the following steps: if the capacity of the allocated memory 152 is less than the capacity of the required amount of memory, storing the first cache table in at least one of the internal volatile memory and the allocated memory 152; and if the allocated memory 152 is not less than the capacity of the required amount of memory, storing the second cache table in at least one of the internal volatile memory and the allocated memory 152.

In addition, whether step S210 specifies the capacity of the required amount of memory or not, step S240 may optionally include the following steps: treating a part of the data stored in the non-volatile storage medium 120 as cache data according to the capacity of the allocated memory 152 and the aforementioned predetermined rule, and storing the cache data and/or a cache table in the allocated memory 152. The cache table indicates the address information of the cache data in the allocated memory 152 and/or the address information of the cache data in the non-volatile storage medium 120. Similarly, if both the allocated memory 152 and the internal volatile memory are available, step S240 may optionally include: storing the cache table in at least one of the allocated memory 152 and the internal volatile memory.

According to the above-disclosure, the device 110 of the present invention is operable to treat the external volatile memory 150 as a cache memory so as to have the storage controller 112 determine whether some to-be-accessed storage data in the non-volatile storage medium 120 is cache data in accordance with a cache table when a host (e.g., the external device 140 or the equivalent thereof) asks the device 110 the to-be-accessed storage data in the non-volatile storage medium 120. If the storage data is cache data, the storage controller 112 is operable to carry out the following step: sending an instruction or the like to ask the external volatile memory 150 to output the storage data to the device 110 and having the storage data be outputted to the host from the device 110; or having the external volatile memory 150 output the storage data to the host directly through a specialized driver. It should be noted that the storage controller 112 may carry out the aforementioned steps S210˜S240 and the derivative step(s) thereof during or after the booting procedure of the device 110.

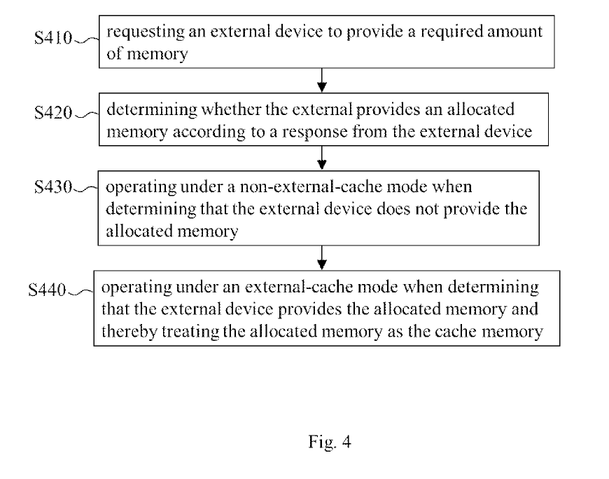

In addition to the aforementioned device, the present invention also discloses a method capable of using an external volatile memory. This method is carried out by the aforementioned device of the present invention or the equivalent thereof, and operable to treat at least a part of an external volatile memory dominated by an external device as a cache memory under an external-cache mode. An embodiment of the method is shown in FIG. 4, and includes the following steps:
Step S410: requesting the external device to provide a required amount of memory.
Step S420: determining whether the external device provides an allocated memory according to a response from the external device.
Step S430: operating under a non-external-cache mode when determining that the external device does not provide the allocated memory.
Step S440: operating under the external-cache mode when determining that the external device provides the allocated memory and thereby treating the allocated memory as the cache memory.

Since those of ordinary skill in the art can appreciate the detail and modification of the above-described method embodiment by referring to the disclosure of the aforementioned device embodiments, which means that the features of the device embodiments can be applied to the method embodiment in a reasonable way, therefore repeated and redundant description is omitted provided that the written description and enablement requirements are still fulfilled.

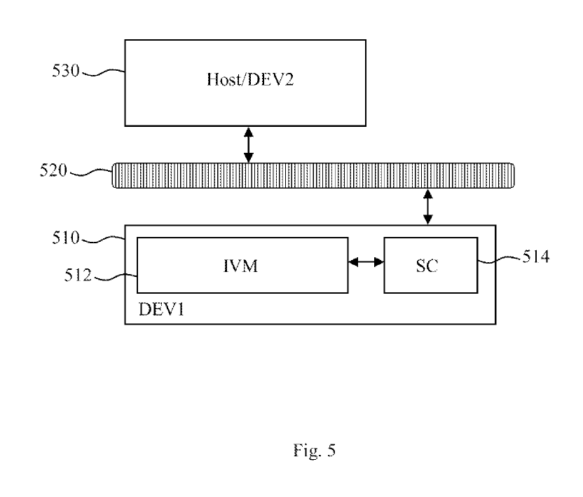

The preceding paragraph mentions that the external volatile memory could be released from some external storage device in accordance with at least one of a protocol and a driver. Therefore, the present invention further discloses a device capable of releasing an internal volatile memory for those of ordinary skill in the art to understand and carry out such device. An embodiment of the device is shown in FIG. 5. The device 510 (which is labeled with “DEV1”) of FIG. 5 includes: a volatile memory 512 (which is labeled with “IVM”); and a storage controller 514 (which is labeled with “SC”). The storage controller 514 is operable to communicate with an external device 530 (which is labeled with “Host/DEV2”) through a transmission interface 520 according to at least one of a driver and a protocol, and operable to release at least a part of the non-volatile memory 512 according to at least one of the driver and the protocol for the external device 530 to dominate the at least a part of the non-volatile memory 512. The driver and protocol can be realized with well-known techniques and the content of the driver or protocol should include code or program code in association with the steps carried out by the storage controller 514. In practice, one of ordinary skill in the art can draft and edit the code and/or program code in accordance with the present disclosure, well-known specification (e.g., PCI-Express specification and/or NVM-Express specification), and available software/firm editing tool. The external device 530 could be a personal computer, a mobile device or a non-volatile storage device. If the external device is a host such as the personal computer or the mobile device, after the host acquires the right to dominate the at least a part of the memory 512, it will transfer the right to another storage device (e.g., the device 110 of FIG. 1 while the at least a part of the memory 512 is equivalent to the allocated memory 152 of FIG. 1). Besides, the storage controller 512 may optionally execute the following steps after releasing the at least a part of the volatile memory 512: building a cache table in the unreleased part of the volatile memory 512 according to the capacity of the unreleased part and/or storing cache data in the unreleased part according to the capacity of the unreleased part, in which the capacity of the volatile memory 512 is substantially equivalent to or greater than the summation of the capacities of the unreleased part and the part released to the external device 530, and the cache table indicates the address information of the cache data in the unreleased part and/or the address information of the cache data in a non-volatile storage medium (not shown). The non-volatile storage medium could be a flash memory and included in the device 510 or independent of the device 510 while the cache data can be retrieved from the non-volatile storage medium. It should be noted that the storage controller 514 may execute the aforementioned steps or the derivative step(s) thereof during or after the booting procedure of the device 510.

Similarly, since those of ordinary skill in the art can appreciate the detail and modification of the embodiment of FIG. 5 by referring to the disclosure of the aforementioned embodiments, which means that the features of the aforementioned embodiments can be applied to the embodiment of FIG. 5 in a reasonable way, therefore repeated and redundant description is omitted provided that the written description and enablement requirements are still fulfilled.

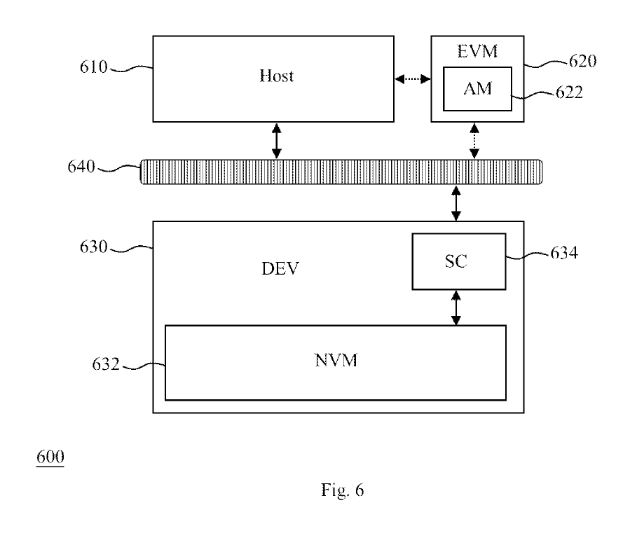

In addition to the aforementioned device and method, the present invention also discloses a system capable of proving cache space. An embodiment of the system is shown in FIG. 6. The system 600 of FIG. 6 comprises: an external device 610 (which is labeled with “Host”) operable to control an external volatile memory 620 (which is labeled with “EVM”) directly or indirectly; and a storage device 630 (which is labeled with “DEV”). The storage device 630 includes: a non-volatile storage medium 632 (which is labeled with “NVM”); and a storage controller 634 (which is labeled with “SC”). The said storage controller 634 is operable to control data access of the non-volatile storage medium 632, and operable to communicate with the external device 610 through a transmission interface 640 in accordance with a protocol and/or a driver. The storage controller 634 is operable to treat at least a part of the external volatile memory 620 as a cache memory (i.e., the allocated memory 622 (which is labeled with “AM”) under an external-cache mode) by executing the following steps: requesting the external device 610 to provide a required amount of memory; detecting whether the external device 610 provides an allocated memory 622 according to a response from the external device 610; operating under a non-external-cache mode if the external device 610 does not provide the allocated memory 522; and operating under the external-cache mode if the external device 610 provides the allocated memory 622 and thereby treating the allocated memory 622 as the cache memory. In this embodiment, the external device 610 is a computer host and the non-volatile storage medium 622 is a flash memory.

Since those of ordinary skill in the art can appreciate the detail and modification of the system embodiment by referring to the disclosure of the aforementioned device and method embodiments, which means that the features of the aforementioned device and method embodiments can be applied to the system embodiment in a reasonable way, therefore repeated and redundant description is omitted provided that the written description and enablement requirements are still fulfilled.

In summary, the device and method capable of using an external volatile memory, the device capable of releasing an internal volatile memory and the system capable of providing cache space of the present invention balance the cost of using cache memory and the requirement of performance. To a general user, using the system memory of a personal computer as the cache memory of a storage device will not substantially affect the performance of the computer, but will significantly improve the performance of the storage device; and using the memory of some device (e.g., an external storage device) as the cache memory of a storage device adopting the present invention will achieve resource sharing and will accomplish or improve uniformity of usage and lifetime of devices in participation.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A device capable of using an external volatile memory, comprising:
a storage controller operable to control data access of a non-volatile storage medium and communicate with an external device, the external device controlling an external volatile memory and the storage controller being operable to treat at least a part of the external volatile memory as a cache memory under an external-cache mode through the following steps:
requesting the external device to provide a required amount of memory;
detecting whether the external device provides an allocated memory according to a response to the request of the required amount of memory from the external device;
operating under a non-external-cache mode if the external device does not provide the allocated memory; and
operating under the external-cache mode if the external device provides the allocated memory, and thereby treating the allocated memory as the cache memory.

2. The device of claim 1, wherein the step of requesting the external device to provide the required amount of memory includes specifying the capacity of the required amount of memory, and the step of treating the allocated memory as the cache memory includes:
determining whether the capacity of the allocated memory is smaller than the capacity of the required amount of memory;
if the capacity of the allocated memory is smaller than the capacity of the required amount of memory, storing first cache data of a first storage amount and/or a first cache table to the allocated memory, in which the first cache data is retrieved from the non-volatile storage medium and the first cache table indicates address information of the first cache data in the allocated memory and/or address information of the first cache data in the non-volatile storage medium; and
if the capacity of the allocated memory is not smaller than the capacity of the required amount of memory, storing second cache data of a second storage amount and/or a second cache table to the allocated memory, in which the second cache data is retrieved from the non-volatile storage medium, the second cache table indicates address information of the second cache data in the allocated memory and/or address information of the second cache data in the non-volatile storage medium, and the second storage amount is greater than the first storage amount.

3. The device of claim 2, wherein the data amount of the second cache table is greater than the data amount of the first cache table.

4. The device of claim 2, further comprising an internal volatile memory, wherein the step of treating the allocated memory as the cache memory further includes:
if the capacity of the allocated memory is smaller than the capacity of the required amount of memory, storing the first cache table to at least one of the internal volatile memory and the allocated memory; and
if the capacity of the allocated memory is not smaller than the capacity of the required amount of memory, storing the second cache table to at least one of the internal volatile memory and the allocated memory.

5. The device of claim 1, wherein the storage controller asks the external device to provide the required amount of memory according to the capacity of the non-volatile storage medium and specifies the capacity of the required amount of memory.

6. The device of claim 1, wherein the step of treating the allocated memory as the cache memory includes:
treating a part of the data stored in the non-volatile storage medium as cache data according to the capacity of the allocated memory and a predetermined rule, and storing the cache data and/or a cache table to the allocated memory, in which the cache table indicates address information of the cache data in the allocated memory and/or address information of the cache data in the non-volatile storage medium.

7. The device of claim 6, further comprising an internal volatile memory, wherein the step of treating the allocated memory as the cache memory further includes:
storing the cache table to at least one of the internal volatile memory and the allocated memory.

8. The device of claim 1, wherein the external volatile memory is included in one of the external device and a storage device, and the external volatile memory is released from the storage device to the external device when the external volatile memory is included in the storage device.

9. A device capable of releasing an internal volatile memory, comprising:
a volatile memory; and
a storage controller operable to communicate with an external device and release at least a part of the volatile memory to the external device, and operable to execute the following step after the release of the at least a part of the volatile memory:
building a cache table and storing the cache table in an unreleased part of the volatile memory according to the capacity of the unreleased part and/or storing cache data in the unreleased part according to the capacity of the unreleased part,
wherein the cache table indicates address information of the cache data in the unreleased part.

10. The device of claim 9, further comprising a non-volatile storage medium, wherein the cache data is retrieved from the non-volatile storage medium.
